(19) United States
(12) Patent Application Publication
(10) Pub. No.: US 2005/0011716 A1
(43) Pub. Date: Jan. 20, 2005

(54) Module for actuators in a vehicle

(76) Inventor: Rudiger Nitzschke, Langenargen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/489,931

(22) PCT Filed: Aug. 30, 2002
(86) PCT No.: PCT/EP02/09713

(30) Foreign Application Priority Data
Sep. 24, 2001 (DE) 101 46 958.6

(51) Int. Cl. B60K 41/22

(52) U.S. Cl. 192/3.55

(57) ABSTRACT

A shift device for a gearbox (8) of a motor vehicle (2) comprising actuators for a first drive device in order to perform a selection movement of the shift device with a first electric motor (36) and for a second drive device in order to perform a selection movement of the shift device with a second electric motor (52), in addition to a control unit (50) which receives sensor signals, processes said sensor signals and transmits control signals to the electric motors (36, 52). The first and second drive device are arranged in a module (34) together with another actuator for a third drive device in order to perform an adjusting movement of a clutch device (6), provided with a third electric motor (62).

According to the preamble of claim 1, the invention relates to a module for actuators in a vehicle.

Shift devices in selector transmissions usually comprise one setting device mounted on the selector transmission which adjusts elements in the selector transmission in accordance with selection and shifting commands of the vehicle driver. The commands can be transmitted to the setting device mechanically or electrically. It is also known that the selection and shifting commands are automatically produced and transmitted to the setting device according to preset computer rules and that thereafter the transmission is shifted. Besides the commands for the shift device of the selector transmission, there can be accordingly delivered manually or automatically produced commands for adjustment of a friction clutch between a prime mover and the selector transmission on a clutch adjustment device placed on the friction clutch. U.S. Pat. No. 6,016,717 has disclosed a shift device for an automatic transmission in which selection and shift commands transmitted by the driver via a manual switch to a manual shift lever are converted in electric signals and from there relayed to an electric motor mounted on the transmission. The electric motor shifts the setting device in the transmission via a cable control. EP 0 377 848 B1 has disclosed a shift device having one adjusted electromechanical transmission placed directly on the transmission and in which a shift finger is guided by two electric motors to two movement axes standing perpendicular to each other. The shift device is situated directly on the transmission and its dimensions must be adapted to the transmission housing. The shift device is also affected by the vibrations, temperatures and pollution to which a transmission is exposed.

The problem on which the invention is based is to improve an electromechanical shift device.

The problem is solved by a shift device with one module for actuators having the features of claim 1. Developments are object of sub-claims.

A shift device for a transmission of a vehicle, according to the invention, comprises actuators for a first drive device to exert a selection movement of the shift device with one first electric motor and for a second drive device to exert a shift movement of the shift device with a second electric motor. A control is provided for receiving sensor signals, for processing the sensor signals and for issuing control signals to the electric motors. The first and the second drive devices are provided in one module together with another actuator for a third drive device to execute an adjustment movement of a clutch device which has a third electric motor. In one embodiment, the electric motor for the selection movement and the electric motor for the shifting movement are each connected with one control cable transmission which acts upon one element of the shift device on or in the transmission. In one other embodiment the electric motor for the selection movement and the electric motor for the shifting movement are each connected with a master cylinder for actuation fluid of the shift device which acts via a fluid pipe upon a slave cylinder on the shift device on or in the transmission. The electric motor for the adjustment movement of the clutch device is preferably connected with a master cylinder for actuation fluid of the clutch device which acts via a fluid pipe on a slave cylinder on the clutch. The fluid is advantageously air or a hydraulic fluid. In one embodiment, directional sensors are provided on the electric motors to detect the adjustment path of the respectively actuated element and whose signals are fed to the control. The sizes of the electric motors are preferably different, since the force needed for the selection movement can fall lower than the force needed for the shifting movement or the adjustment movement of the clutch. In a particularly advantageous embodiment, the module is situated in the vehicle in an arbitrary position. The module can be placed in the vehicle where there is sufficient space, danger or damage can be kept small, or the system in the module is not exposed to the vibrations and temperatures and other environmental influences such as usually prevail directly on the transmission and thus the best possible protection for the system can be achieved. By virtue of such a module, it is possible to undertake a subsequent automated shifting on a multiplicity of selector transmissions, since only small consideration has to be given to a space requirement.

The invention is explained in detail with reference to a drawing which shows:

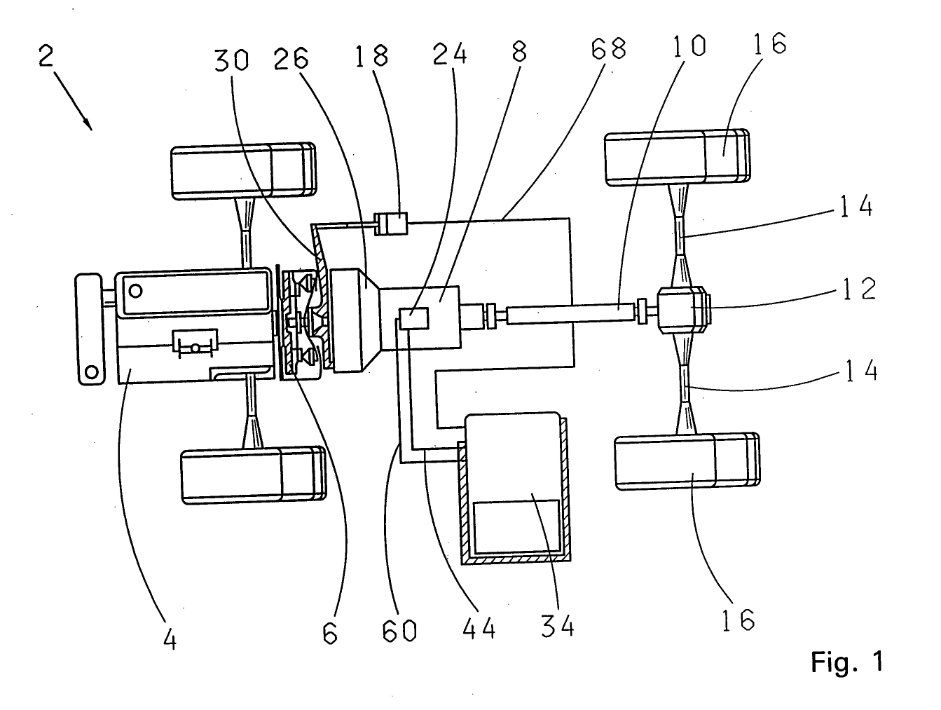

FIG. 1 a diagrammatic representation of a vehicle and

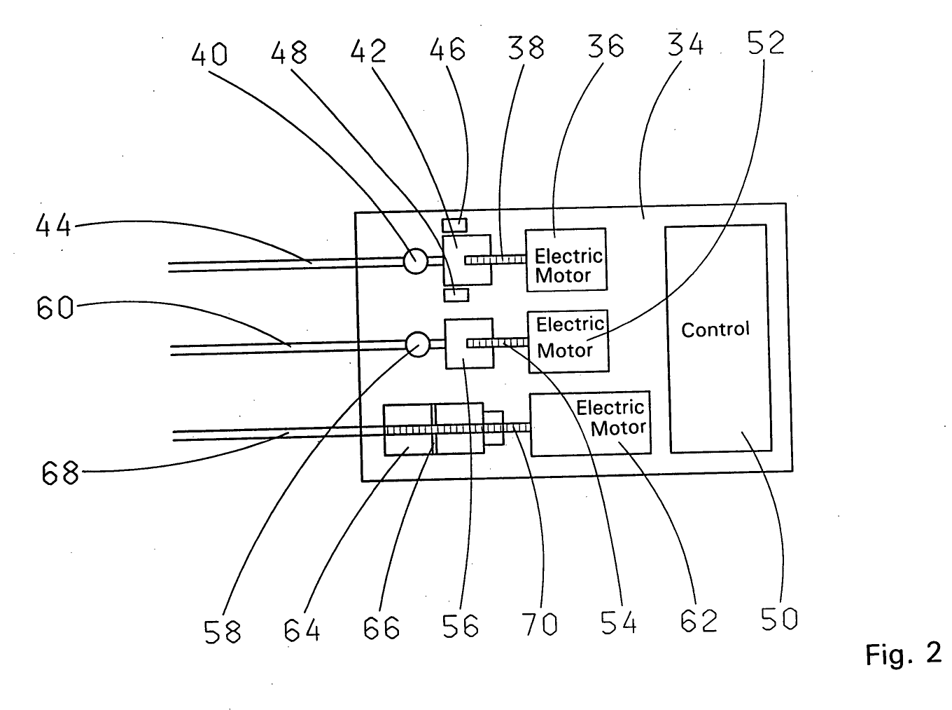

FIG. 2 a module of the shift device.

FIG. 1 shows a diagrammatic representation of a vehicle 2 with a prime mover 4 which acts upon a transmission 8 via a friction clutch 6. The transmission 8 is connected via an output shaft 10 with a differential 12 which drives a vehicle 16 via a respective half axle 14. The friction clutch 6 is actuated by a slave cylinder 18 of a clutch adjustment device which, via a fluid pipe 68, is connected with a module 34. The transmission 8 is actuated by a transmission controller 24 of a shift device which is located on a housing 26 of the transmission 8 and is connected with the module 34 via a control cable 44 for performing a selection movement and via a control cable 60 for performing a shifting movement.

FIG. 2 shows, as part of the shift device, one module 34 in which one first electric motor 36 is provided for the selection movement. During a rotation of the electric motor 36, a spindle 38 is turned and adjusts a spindle nut 42 on which the control cable 44 is fastened via an adapter 40. Laterally on the spindle nut 42, a directional sensor 46 is situated with which an adjustment movement of the spindle nut 42 is detected and can be relayed as signal to a control 50. A second electric motor 52 for the selection movement is situated next to the first electric motor 36. During rotation of the electric motor 52, a spindle 54 is turned and adjusts a spindle nut 56 on which the cable control 60 is fastened via an adapter 48. Laterally on the spindle nut 56 a directional sensor 48 is located with which an adjustment movement of the spindle nut 56 is detected and can be relayed as signal to the control 50. A third electric motor 62 is situated next to the first two electric motors 36 and 52. During rotation of the electric motor 62, due to rotation of a spindle 70 in a master cylinder 64, a piston 66 is displaced which moves fluid in the master cylinder 64 and relays it via the fluid pipe 68 to the slave cylinder 18 of the friction clutch 6.

The electric motors 36, 52, 62 and the control 50 are supplied via pipes (not shown here) with electric energy and control signals by a manual shift device or one other control in which, according to preset computer rules, shifting commands are produced for the electric motor 36, 52, 62.

### Reference Numerals

2 vehicle
4 prime mover
6 friction clutch
8 transmission
10 output shaft
12 differential
14 half axle
16 vehicle wheel
18 slave cylinder
24 transmission controller
26 housing
34 module
36 electric motor
38 spindle
40 adapter
42 spindle nut
44 control cable
46 directional sensor
48 directional sensor
50 control
52 electric motor
54 spindle
56 spindle nut
58 adapter
60 control cable
62 electric motor
64 master cylinder
66 piston
68 fluid pipe
70 spindle

1-9. (canceled)

10. A shift device for a transmission (8) of a vehicle (2) comprising actuators for a first drive device for performing a selection movement of said shift device with a first electric motor (36), for a second drive device for performing a shifting movement of the shift device with a second electric motor (52) and one control (50) for receiving sensor signals, for processing the sensor signals and for issuing control signals to said first and second electric motors (36, 52), wherein said first and second drive devices are provided in one module (34) together with one other actuator for a third drive device for performing an adjustment movement of a clutch device (6) which has a third electric motor (62).

11. The shift device according to claim 10, wherein said first electric motor (36) for the selection movement and said second electric motor (52) for the shifting movement are each connected with one control cable (44, 60) which acts upon at least one of one element of said shift device on or in said transmission (8).

12. The shift device according to claim 10, wherein said first electric motor (36) for the selection movement and said second electric motor (52) for the shifting movement are each connected with one master cylinder for actuation fluid of said shift device which via a fluid pipe acts upon a slave cylinder on said shift device on or in said transmission (8).

13. The shift device according to claim 10, wherein said second electric motor (52) for the adjustment movement of said clutch device (6) is connected with a master cylinder (64) for actuation fluid of said clutch device (6) which via a fluid pipe (68) acts upon a slave cylinder (18) on said clutch device (6).

14. The shift device according to claim 10, wherein said fluid is air.

15. The shift device according to claim 10, wherein said fluid is a hydraulic fluid.

16. The shift device according to claim 10, wherein directional sensors (46, 48) are provided on said first, second and third electric motors (36, 52, 62) for detecting adjustment paths of the respectively actuated element.

17. The shift device according to claim 10, wherein sizes of said electric motors (36, 52, 62) are different.

18. The shift device according to claim 10, wherein said module (34) is situated on an arbitrary position in said vehicle (2).
